(19) United States
(12) Patent Application Publication
(10) Pub. No.: US 2010/0085408 A1
(43) Pub. Date: Apr. 8, 2010

(54) Printing method for thermal printer, computer program, and thermal printer apparatus

(76) Inventors: Koichi Hatakeyama, Chiba-shi (JP); Akio Naito, Chiba-shi (JP); Sayaka Gamo, Chiba-shi (JP)

Correspondence Address: BRUCE L. ADAMS, ESQ.;ADAMS & WILKS, SUITE 1231, 17 BATTERY PLACE, NEW YORK, NY, 10004, US

(21) Appl. No.: 12/587,343

(22) Filed: Oct. 6, 2009

(30) Foreign Application Priority Data
Oct. 7, 2008 (JP) 2008-260846

(51) Int. Cl. B41J 2/00

(52) U.S. Cl. 347/188

(57) ABSTRACT

To reduce sticking without increasing a print time period in a thermal printer, a printing method comprises: an energizing start delay time calculating procedure of calculating delay time from end of paper feed of the thermal paper until start of energizing of the thermal head based on interval time of paper feed of the thermal paper that is performed in a step manner and energization time for energizing the thermal head correspondingly to data to be printed; a measuring procedure of measuring elapsed time after the end of the paper feed of the thermal paper; an energizing procedure of energizing the thermal head after the delay time calculated in the energizing start delay time calculating procedure has passed based on a result of the measurement obtained in the measuring procedure; and a paper feed procedure of moving the thermal paper in a step manner after end of the energization of the thermal head in the power supplying procedure.

### BACKGROUND OF THE INVENTION

1. Field of the Invention

The present invention relates to a printing method, a computer program, and a thermal printer apparatus that reduce sticking between a paper and a thermal head of a thermal printer.

2. Description of the Related Art

Conventionally, a thermal printer, which prints on rolled thermal paper that is used for cash register tape or the like, feeds the paper during recording by driving a stepping motor. Further, after finishing the paper feed, electric power is supplied to a thermal head so that heat is applied to the thermal head for printing. In other words, electric power is supplied to a thermal head at a timing just after driving the stepping motor for feeding paper. Therefore, during a period of time from finishing the power supply (for printing) to the thermal head for the current line until the paper is fed to the next line, a heating element of the thermal head and a heated part of the thermal paper are retained at the same position. If the period of time from finishing the power supply (for printing) to the thermal head until driving the stepping motor (for paper feed) is long in this state, a so-called sticking may occur easily, which is a phenomenon that the heating element of the thermal head sticks to the printed part of the thermal paper due to a coloring component contained in the thermal paper. As an amount of heat applied to the thermal head for printing the current line (corresponding to a ratio of heated heating elements in the thermal head) is larger, and as temperature of environment of the thermal printer is lower, the sticking occurs more easily.

Patent Document JP 10-109435 A discloses a method in which for reducing such sticking, if it is decided to be a state where sticking will occur, the thermal head is supplied with extremely little current (that cannot print on the thermal paper but can generate heat for melting the coloring component of the thermal paper by the heating element of the thermal head) so that the coloring component of the thermal paper that sticks to the thermal head can be melted, and afterward the paper feed is performed.

However, there is a problem that a print time period becomes longer if the supply of the extremely little current is added to the thermal head for melting the coloring component of the thermal paper sticking to the thermal head after deciding the sticking as described in Patent Document JP 10-109435 A.

### SUMMARY OF THE INVENTION

The present invention has been made in view of the recognition of the problem described above, and an object thereof is to provide a printing method for a thermal printer, a computer program, and a thermal printer apparatus that reduces the sticking without increasing the print time period in a thermal printer that performs printing by energizing the thermal head.

In order to solve the above-mentioned problem, according to the present invention, a printing method for a thermal printer apparatus that energizes a thermal head so that a heating element generates heat to perform printing on a thermal paper by generating the heat, comprises: an energizing start delay time calculating procedure of calculating delay time from end of paper feed of the thermal paper until start of energizing of the thermal head based on interval time of paper feed of the thermal paper that is performed in a step manner and energization time for energizing the thermal head correspondingly to data to be printed; a measuring procedure of measuring elapsed time after the end of the paper feed of the thermal paper; an energizing procedure of energizing the thermal head after the delay time calculated in the energizing start delay time calculating procedure has passed based on a result of the measurement obtained in the measuring procedure; and a paper feed procedure of moving the thermal paper in a step manner after end of the energization of the thermal head in the power supplying procedure.

Further, the energizing start delay time calculating procedure according to the present invention includes calculating the delay time until the start of the energization of the thermal head by subtracting the energization time for energizing the thermal head correspondingly to the data to be printed from the interval time of paper feed of the thermal paper.

Further, the energizing start delay time calculating procedure according to the present invention includes summing up all pieces of the energization time for sequentially energizing the thermal head, the energization time being divided into a plurality of segments in the same line on the thermal paper correspondingly to the data to be printed; and subtracting the summed-up all pieces of energization time from the interval time of paper feed of the thermal paper so as to calculate the delay time from the end of the paper feed of the thermal paper until the start of energizing of the thermal head.

Further, a computer program according to the present invention causes a computer that controls a thermal printer apparatus that energizes a thermal head so that a heating element generates heat to perform printing on thermal paper by generating the heat, to execute: means for calculating delay time from end of paper feed of the thermal paper until start of energizing of the thermal head based on interval time of paper feed of the thermal paper that is performed in a step manner and energization time for energizing the thermal head correspondingly to data to be printed; means for measuring elapsed time after the end of the paper feed of the thermal paper; means for energizing the thermal head after the calculated delay time has passed based on the measured elapsed time; and means for moving the thermal paper in a step manner after end of the energization of the thermal head.

Further, according to the present invention, a thermal printer apparatus that energizes a thermal head so that a heating element generates heat to perform printing on a thermal paper by generating the heat, comprises: energizing start delay time calculating means for calculating delay time from end of paper feed of the thermal paper until start of energizing of the thermal head based on interval time of paper feed of the thermal paper that is performed in a step manner and energization time for energizing the thermal head correspondingly to data to be printed; measuring means for measuring elapsed time after the end of the paper feed of the thermal paper; energizing means for energizing the thermal head after the delay time calculated by the energizing start delay time calculating means has passed based on a result of the measurement by the measuring means; and paper feed means for moving the thermal paper in a step manner after end of the energization of the thermal head by the power supplying means.

According to the present invention, it is possible in a thermal printer that performs printing by energizing the thermal head to decrease a time period from finishing of the energization (for printing) of the thermal head until driving of the stepping motor (for paper feed), whereby a time period in which the heating element of the thermal head and the heated part of the thermal paper are retained at the same position can be shortened. Therefore, it is possible to obtain the effect of reducing the sticking without increasing the print time period.

### BRIEF DESCRIPTION OF THE DRAWINGS

In the accompanying drawings:

FIG. 1 is a block diagram illustrating a schematic structure of a print control unit in a print system according to an embodiment of the present invention;

FIG. 2 is a timing chart illustrating an outline of a printing method according to this embodiment;

FIG. 3 is a flowchart illustrating a process procedure of the printing method according to this embodiment;

FIG. 4 is another timing chart illustrating an outline of a printing method according to this embodiment;

FIG. 5 is a timing chart illustrating an outline of a conventional printing method; and

FIG. 6 is another timing chart illustrating an outline of a conventional printing method.

### DETAILED DESCRIPTION OF THE PREFERRED EMBODIMENT

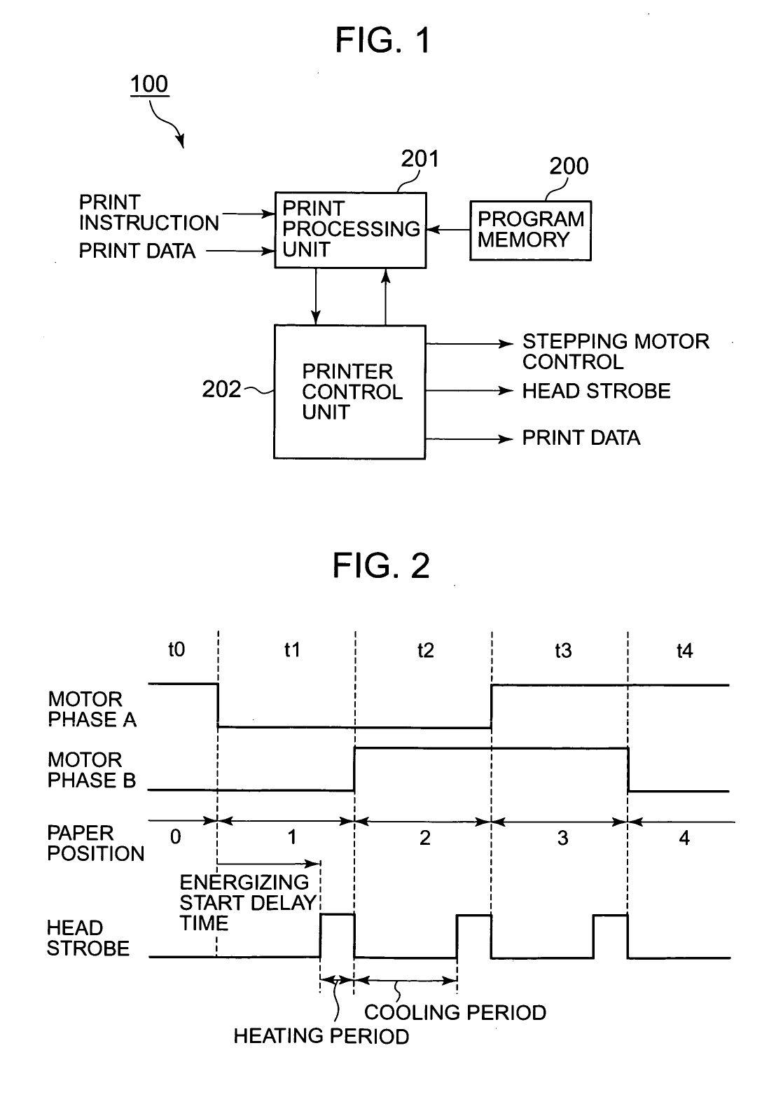

Now, an embodiment of the present invention is described with reference to the attached drawings. FIG. 1 is a block diagram illustrating a schematic structure of a print control unit in a print system according to the embodiment of the present invention. In FIG. 1, the print control unit 100 includes a program memory 200, a print processing unit 201, and a printer control unit 202. Note that the print control unit 100 controls energization (for printing) of the thermal head and drive of the stepping motor (for feeding the thermal paper) in accordance with a print instruction received from control means (not shown) so that a connected thermal printer apparatus (not shown) is caused to print based on print data received from the control means.

The program memory 200 is a memory for storing a system program that is used for general control of the print system according to this embodiment and is read by the print processing unit 201 described below.

The print processing unit 201 is processing means such as a central processing unit (CPU) for controlling the printer control unit 202 in accordance with the print instruction received from the control means, which is described below.

When the print system of this embodiment is powered on, the print processing unit 201 reads the system program from the program memory 200 and enters into a print waiting state. When the print instruction is received, the print processing unit 201 issues a print start instruction to the printer control unit 202 described later and also outputs the received print data to the printer control unit 202 described later so as to perform a printing process. Note that the printing process performed by the print processing unit 201 includes dividing the received print data into data for individual lines to be printed and outputting the divided print data for each line every time when a print end signal is received from the printer control unit 202 described later.

The printer control unit 202 is a block for controlling the thermal printer apparatus in accordance with the print start instruction and the print data received from the print processing unit 201.

When the print start instruction is received from the print processing unit 201, the printer control unit 202 calculates a step time of the stepping motor (interval from the line to be printed this time to the next line). In addition, the printer control unit 202 calculates a head strobe time (time period for energizing the thermal head so as to apply heat of the thermal head to the thermal paper) based on the print data received from the print processing unit 201. In addition, the printer control unit 202 subtracts the calculated head strobe time from the calculated step time of the stepping motor so as to calculate an energizing start delay time (head strobe output start time) for the thermal head of the thermal printer apparatus controlled by the printer control unit 202.

The printer control unit 202 outputs a stepping motor control signal to the thermal printer apparatus controlled by the printer control unit 202 so that the paper is moved to a print position of the next line (feeds the paper). Next, after the calculated energizing start delay time for the thermal head has passed, print data and a head strobe signal are output to the thermal printer apparatus controlled by the printer control unit 202 for each line to be printed.

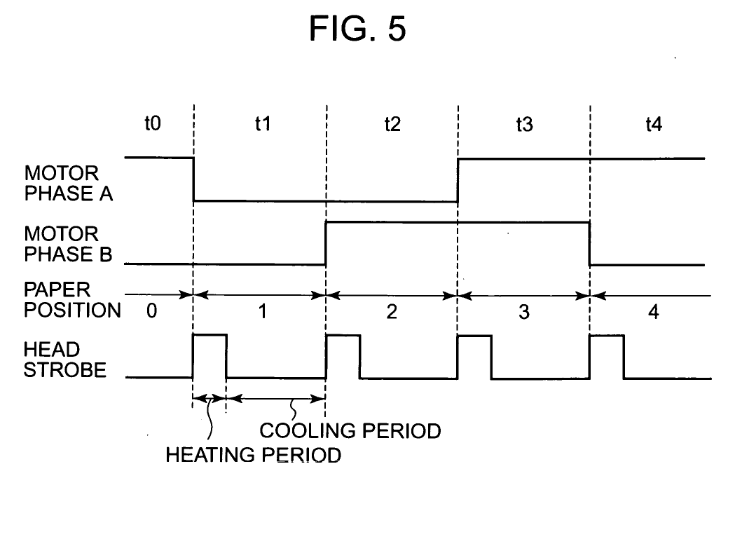

Next, a printing method of this embodiment is described. FIG. 2 is a timing chart illustrating an outline of a printing method for a thermal printer according to the print system according to the embodiment of the present invention. In addition, FIG. 5 is a timing chart illustrating an outline of a conventional printing method in association with FIG. 2. In addition, a method of energizing the thermal head for printing and a method of processing data to be printed are not defined in the present invention. Further, although a two-phase driving is used for driving the stepping motor in FIGS. 2 and 5, a driving method of the stepping motor for paper feed is not defined in the present invention.

As illustrated in FIG. 2, when a print command (not shown) is received, the printer control unit 202 calculates the energizing start delay time for the thermal head in the t0 period by subtracting a time period for energizing the thermal head for printing in the t1 period (head strobe time) from the next t1 period (that is a time period from the start of the t1 period until starting of the paper feed for printing the next line, i.e., step time of the stepping motor). Next, the printer control unit 202 performs the paper feed by driving the stepping motor for printing in the t1 period.

When the position of the paper reaches the position for printing (paper position=1), the printer control unit 202 starts to measure elapsed time from the current time (start of the t1 period) in the t1 period and outputs high level to the head strobe when the measured elapsed time is equal to the energizing start delay time for the thermal head so that the thermal head is energized. Thus, the heating element of the thermal head generates heat so that the coloring component contained in the thermal paper is melted for printing. Next, the printer control unit 202 outputs low level to the head strobe (finishes the head strobe output) when the time period for energizing the thermal head has passed. Then, the printer control unit 202 calculates the energizing start delay time for the thermal head for printing in the next period (t2 period) and drives the stepping motor for paper feed so as to perform the next printing (printing in the t2 period).

When the paper position reaches the position for printing (paper position=2), the printer control unit 202 outputs high level to the head strobe so as to energize the thermal head for printing on the thermal paper in the t2 period as in the t1 period when the elapsed time from the start of the t2 period is equal to the energizing start delay time for the thermal head calculated in the t1 period. After that, the printer control unit 202 outputs low level to the head strobe when the time period for energizing the thermal head has passed and calculates the energizing start delay time for the thermal head in the next period (t3 period) so as to perform the paper feed. Also after the t3 period, printing on the thermal paper, calculating of the energizing start delay time for the thermal head, and the paper feed are repeated so that similar operations are carried out until the end of printing.

On the other hand, in the conventional printing method as illustrated in FIG. 5, the head strobe is output for printing on the thermal paper when the paper position reaches the position for printing (paper position=1). Then, when the time for the paper feed comes for printing the next line (t2 period), the stepping motor is driven to feed paper for the next printing.

Here, the sticking occurs when the heating element of the thermal head sticks to the printed part of the thermal paper due to the coloring component contained in the thermal paper in the period in which the thermal head is cooled after the thermal head is energized by outputting the head strobe for printing on the thermal paper. Therefore, if the time period in which the thermal head and the thermal paper are in the same position is long in the cooling period of the thermal head after the head strobe is made to be at low level, the sticking may easily occur.

In the conventional printing method illustrated in FIG. 5, the stepping motor is not driven after finishing the output of the head strobe, and hence the paper position is not changed. Therefore, the cooling period for the thermal head is the period of the paper position, which is the same as the period of outputting the head strobe, e.g., the t1 period. In this embodiment illustrated in FIG. 2, the stepping motor is driven after finishing the output of the head strobe so as to change the paper position. Therefore, the cooling period for the thermal head is the period of the paper position, which is different from the period of outputting the head strobe, e.g., the t2 period. Thus, the sticking hardly occurs.

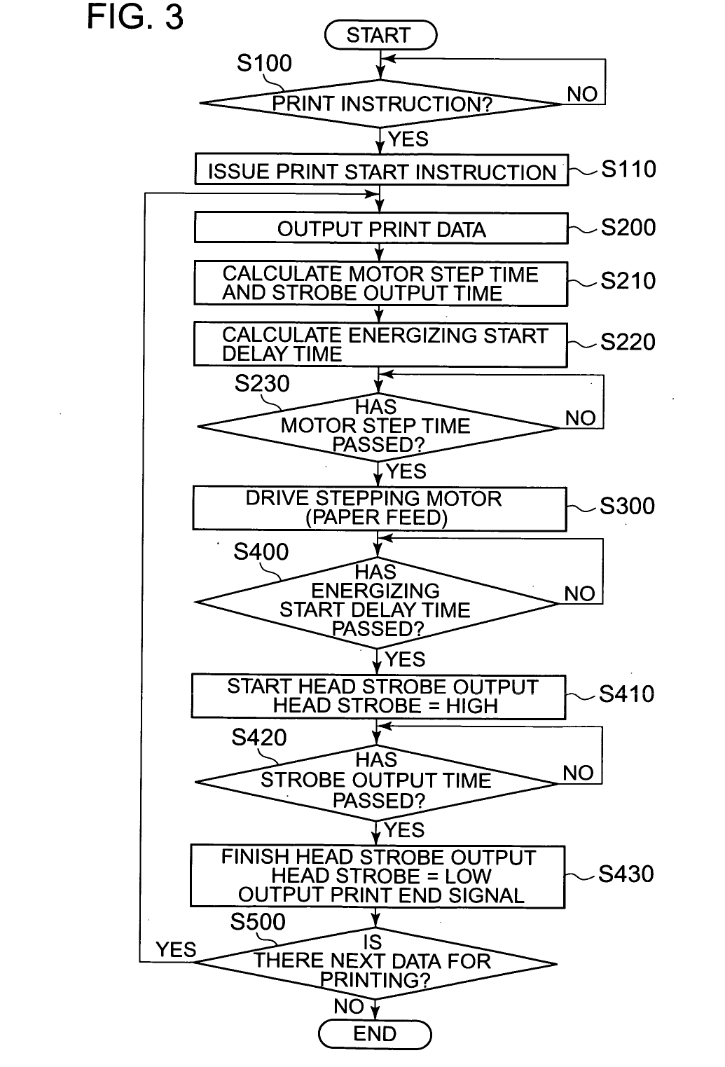

Next, a process procedure of the printing method according to this embodiment is described. FIG. 3 is a flowchart illustrating the process procedure of the printing method according to this embodiment.

First, in Step S100, the print processing unit 201 checks whether or not a print instruction is received from the control means. If the print instruction is received, a print start instruction is issued to the printer control unit 202 in Step S110 so as to start the printing. If the print instruction is not received in Step S100, the process of Step S100 is repeated.

Next, the print processing unit 201 outputs print data of one line to be printed to the printer control unit 202 in Step S200. Next, the printer control unit 202 calculates the step time of the stepping motor for the next line in Step S210. In addition, the printer control unit 202 calculates the head strobe time for the next line (time period for energizing the thermal head) based on the print data for one line received from the print processing unit 201 in accordance with, for example, characteristics of the thermal head.

Next, the printer control unit 202 subtracts in Step S220 the head strobe time of the next line calculated in Step S210 from the step time of the stepping motor calculated in Step S210, to thereby calculate the energizing start delay time for the thermal head.

Next, the printer control unit 202 decides in Step S230 whether or not the step time of the stepping motor for the current line (i.e., time period until the next line) has passed. If the step time of the stepping motor has passed, the stepping motor is driven in Step S300 to move the paper to the print position of the next line (feed the paper). If the step time of the stepping motor has not passed yet in Step S230, Step S230 is repeated so as to continue measuring the time until the step time of the stepping motor passes.

Next, when the drive of the stepping motor is finished and the thermal paper is fed to the line for printing this time in Step S300, the printer control unit 202 decides in Step S400 whether or not the time until the energizing start delay time for the thermal head has passed. If the time until the energizing start delay time has passed, high level is output to the head strobe in Step S410 so that the thermal head is energized. If the time until the energizing start delay time has not passed yet in Step S400, Step S400 is repeated so as to continue measuring the time until the energizing start delay time.

Next, the printer control unit 202 decides in Step S420 whether or not the period of outputting the head strobe of high level has passed. If the period of outputting the head strobe of high level has passed, low level is output to the head strobe in Step S430 so as to stop energization of the thermal head. In addition, the printer control unit 202 outputs the print end signal to the print processing unit 201. If the period of outputting the head strobe of high level has not passed in Step S420, Step S420 is repeated so as to continue measuring the time until the period of outputting the head strobe of high level passes. The head strobe of high level is output in the period from Step S410 to Step S430, and therefore, the heating element of the thermal head generates heat so that heat is applied to the thermal paper. Thus, the coloring component contained in the thermal paper is melted to perform the printing.

Next, the print processing unit 201 checks in Step S500 whether or not there is print data to be printed next. If there is print data to be printed next, the process returns to Step S200, and the next printing process is performed. If there is no print data to be printed next in Step S500, the printing process is finished.

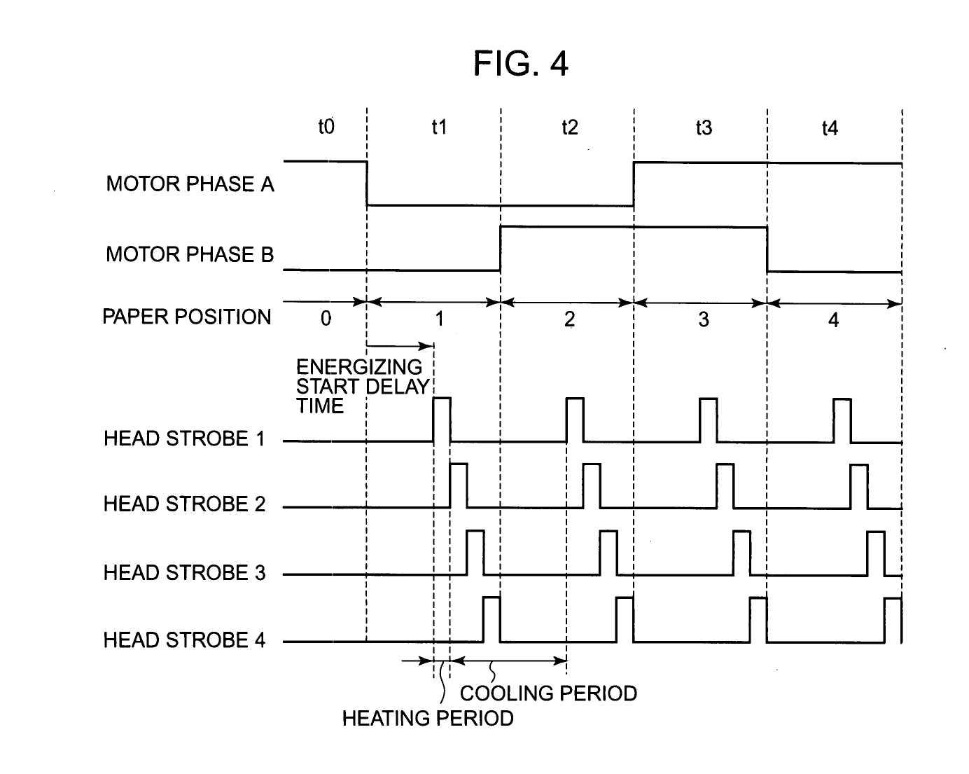

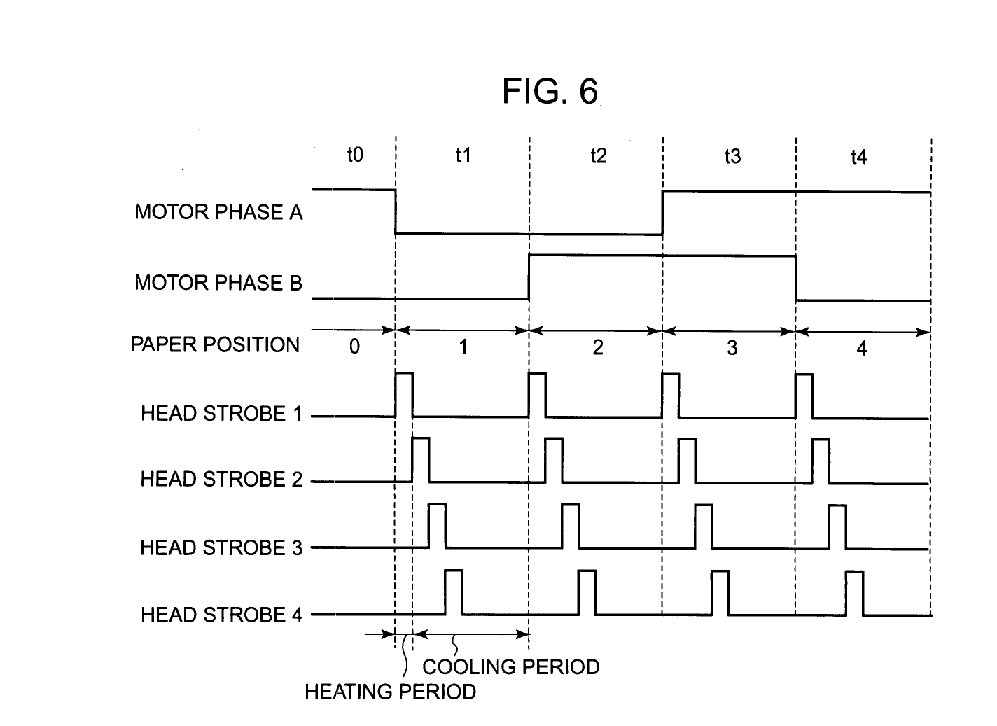

Next, there is described another case, in which the thermal head is divided into a plurality of regions in the print system according to this embodiment, and the head strobes for corresponding regions are output sequentially, to thereby energize the thermal head. FIG. 4 is a timing chart illustrating an outline of a printing method for a thermal printer according to a print system according to the embodiment of the present invention. In addition, FIG. 6 is a timing chart illustrating an outline of a conventional printing method in association with FIG. 4. Further, the head strobe for printing is divided into four regions as illustrated in FIGS. 4 and 6 in the following description, but the number of division of the head strobe is not specified in the present invention.

When a print command (not shown) is received as illustrated in FIG. 4, the printer control unit 202 calculates, in the t0 period as in the t0 period of FIG. 2, the energizing start delay time for the thermal head by subtracting the time period of energizing the thermal head in printing in the t1 period from the time period of the next t1 period. Here, the thermal head is divided into four regions in FIG. 4, and therefore, the time period of energizing the thermal head that is used for calculating is a total sum of time periods of outputting four head strobes corresponding to the four divided regions. Next, the printer control unit 202 drives the stepping motor for paper feed so as to perform the printing in the t1 period.

When the paper position reaches the position for printing (paper position=1), the printer control unit 202 starts measuring the elapsed time from the current time (start of the t1 period) in the t1 period. When the measured elapsed time is equal to the calculated energizing start delay time for the thermal head, the printer control unit 202 outputs high level to the head strobe 1 so as to energize the thermal head. Next, when the time period for energizing the thermal head by the head strobe 1 has passed, the printer control unit 202 outputs low level to the head strobe 1 and outputs high level to the next head strobe 2 so as to energize the thermal head. After that, a head strobe 3 and a head strobe 4 are output. By the head strobes 1 to 4, the heating elements of the corresponding regions of the thermal head are heated to perform the printing. Next, when every head strobe has been output (i.e., low level is output to every head strobe so as to finish the head strobe output), the printer control unit 202 calculates the energizing start delay time for the thermal head for printing in the next period (t2 period) and drives the stepping motor for the paper feed so as to perform the next printing (printing in the t2 period).

When the paper position reaches the position for printing (paper position=2), the printer control unit 202 performs the printing on the thermal paper in the t2 period, as in the t1 period, by sequentially outputting the head strobes 1 to 4 when the elapsed time from the start of the t2 period is equal to the energizing start delay time for the thermal head calculated in the t1 period. The printing on the thermal paper, the calculating of the energizing start delay time for the thermal head, and the paper feed are repeated similarly also in the t3 period and the subsequent period until the print end.

In contrast, in the conventional printing method, as illustrated in FIG. 6, the head strobes 1 to 4 are output sequentially for the printing when the paper position reaches the position for printing (paper position=1), and the stepping motor is driven for the paper feed when it comes to the time for the paper feed for printing the next line (t2 period).

Here, as described above, the sticking occurs in the period of cooling the thermal head.

In the conventional printing method illustrated in FIG. 6, the sticking occurs most easily in the region of the thermal head corresponding to the head strobe 1, in which the period from the end of the head strobe output until the paper feed is the longest due to a difference between the end of the output of the head strobe 1 having high level and the end of the output of the head strobe 4 having high level. Also in the printing method according to this embodiment, the time period from the end of the output of the head strobe 1 having high level until the end of the output of the head strobe 4 having high level as illustrated in FIG. 5 is the same as the time period in the conventional printing method illustrated in FIG. 6, and the cooling period for the thermal head is also the same time period. Therefore, the sticking occurs most easily in the region of the thermal head corresponding to the head strobe 1, in which the period from the end of the head strobe output until the paper feed is the longest. However, in FIG. 4, the stepping motor is driven so as to change the paper position after finishing the output of the head strobe 4 having high level, and therefore, the period having the same paper position after finishing the output of the head strobe 1 having high level, e.g., the t1 period is shorter than that of FIG. 6. In other words, the paper position moves to a position different from that in the period in which the head strobe is output during the cooling period for the region of the thermal head corresponding to the head strobe 1, e.g., in the period from the t1 period to the t2 period, and therefore, the sticking hardly occurs.

As described above, according to the best mode for carrying out the present invention, the sticking can be reduced by driving the stepping motor so as to perform the paper feed during the cooling period for the thermal head. In addition, unlike the conventional printing method, the stepping motor is only driven so as to change the timing for the paper feed, and therefore, the print time period is not elongated.

In addition, the stepping motor is driven for the paper feed after calculating the energizing start delay time for the thermal head, and therefore, it is possible to utilize the waiting time for the paper feed after the head strobe output is finished.

Note that power supply means for the thermal head, a method of processing data to be printed, and paper feed means for the paper are not defined in the present invention.

Note that a function of a part of the print system in the embodiment described above, e.g., a function of the print control unit 100 may be realized with a computer. In this case, the function may be realized by recording a program for realizing the control function on a computer-readable recording medium, and reading and executing the program recorded on the recording medium by a computer system. Note that the “computer system” here includes an OS and hardware such as peripheral devices. In addition, the “computer-readable recording medium” refers to a portable medium such as a flexible disc, an opto-magnetic disk, a ROM, or a CD-ROM, or a storage device such as a hard disk incorporated in the computer system. Further, the “computer-readable recording medium” may include a communication line in the case where the program is transmitted via a network such as the Internet or a communication line such as a telephone line, which dynamically stores the program for a short period of time, and a volatile memory inside the computer system as a server or a client in that case, which stores the program for a constant time. In addition, the program may realize a part of the function described above or may realize the function described above by a combination with the program that is already recorded in the computer system.

The embodiment of the present invention has been described above with reference to the drawings, but the concrete structure is not limited to the embodiment, which can be modified variously within the scope of the present invention without departing from the spirit of the present invention.

What is claimed is:

1. A printing method for a thermal printer apparatus that energizes a thermal head so that a heating element generates heat to perform printing on a thermal paper by generating the heat, comprising:
an energizing start delay time calculating procedure of calculating delay time from end of paper feed of the thermal paper until start of energizing of the thermal head based on interval time of paper feed of the thermal paper that is performed in a step manner and energization time for energizing the thermal head correspondingly to data to be printed;
a measuring procedure of measuring elapsed time after the end of the paper feed of the thermal paper;
an energizing procedure of energizing the thermal head after the delay time calculated in the energizing start delay time calculating procedure has passed based on a result of the measurement obtained in the measuring procedure; and
a paper feed procedure of moving the thermal paper in a step manner after end of the energization of the thermal head in the power supplying procedure.

2. A printing method for a thermal printer apparatus according to claim 1, wherein the energizing start delay time calculating procedure comprises calculating the delay time until the start of the energization of the thermal head by subtracting the energization time for energizing the thermal head correspondingly to the data to be printed from the interval time of paper feed of the thermal paper.

3. A printing method for a thermal printer apparatus according to claim 2, wherein the energizing start delay time calculating procedure comprises:
summing up all pieces of the energization time for sequentially energizing the thermal head, the energization time being divided into a plurality of segments in the same line on the thermal paper correspondingly to the data to be printed; and
subtracting the summed-up all pieces of the energization time from the interval time of paper feed of the thermal paper so as to calculate the delay time from the end of the paper feed of the thermal paper until the start of energizing of the thermal head.

4. A computer program that causes a computer that controls a thermal printer apparatus that energizes a thermal head so that a heating element generates heat to perform printing on a thermal paper by generating the heat, to execute:
means for calculating delay time from end of paper feed of the thermal paper until start of energizing of the thermal head based on interval time of paper feed of the thermal paper that is performed in a step manner and energization time for energizing the thermal head correspondingly to data to be printed;
means for measuring elapsed time after the end of the paper feed of the thermal paper;
means for energizing the thermal head after the calculated delay time has passed based on the measured elapsed time; and
means for moving the thermal paper in a step manner after end of the energization of the thermal head.

5. A thermal printer apparatus that energizes a thermal head so that a heating element generates heat to perform printing on a thermal paper by generating the heat, comprising:
energizing start delay time calculating means for calculating delay time from end of paper feed of the thermal paper until start of energizing of the thermal head based on interval time of paper feed of the thermal paper that is performed in a step manner and energization time for energizing the thermal head correspondingly to data to be printed;
measuring means for measuring elapsed time after the end of the paper feed of the thermal paper;
energizing means for energizing the thermal head after the delay time calculated by the energizing start delay time calculating means has passed based on a result of the measurement by the measuring means; and
paper feed means for moving the thermal paper in a step manner after end of the energization of the thermal head by the power supplying means.
